(19) United States
(12) Patent Application Publication
(10) Pub. No.: US 2016/0093912 A1
(43) Pub. Date: Mar. 31, 2016

(54) LITHIUM-ION BATTERY

(71) Applicant: Dongguan Amperex Technology Limited, Dongguan City (CN)

(72) Inventors: Qiang ZHENG, Dongguan City (CN); Shengwei Wang, Dongguan City (CN); Chao Gao, Dongguan City (CN); Fuping Luo, Dongguan City (CN)

(73) Assignee: Dongguan Amperex Technology Limited, Dongguan City (CN)

(21) Appl. No.: 14/810,314

(22) Filed: Jul. 27, 2015

(30) Foreign Application Priority Data
Sep. 25, 2014 (CN) 201410500074.1

(51) Int. Cl. H01M 10/0525; H01M 4/62; H01M 2/16; H01M 4/66; H01M 10/0568; H01M 4/133; H01M 4/131

(52) U.S. Cl. CPC H01M 10/0525; H01M 4/133; H01M 4/623; H01M 4/131; H01M 4/625; H01M 4/661; H01M 4/622; H01M 10/0568; H01M 2/16; H01M 2300/0091; H01M 2004/021

(57) ABSTRACT

The present invention provides a lithium-ion battery. The lithium-ion battery includes: a positive electrode plate including a positive current collector and a positive conductive membrane which is formed on the surface of the positive current collector by coating, drying and compacting a positive mixture slurry containing a positive active material, a positive conductive additive and a positive binder; a negative electrode plate including a negative current collector and a negative conductive membrane which is formed on the surface of the negative current collector by coating, drying and compacting a negative mixture slurry containing a negative active material, a negative conductive additive and a negative binder; a separator; an electrolyte; and a packaging foil. The compacted density of the positive conductive membrane is at a range from 3.9 g/cm³ to 4.4 g/cm³; the compacted density of negative conductive membrane is at a range from 1.55 g/cm³ to 1.8 g/cm³; the ratio of the capacity of the negative active material to the capacity of the positive active material CB is at a range from 1 to 1.4. The lithium-ion battery of the present invention can be charged quickly at high rate, with excellent safety performance and cycle performance.

### TECHNICAL FIELD

The present invention relates to the field of battery technology, and particularly relates to a lithium-ion battery.

### BACKGROUND

Lithium-ion battery has become an ideal power source used in mobile devices for replacing the conventional power source, due to the advantages of high energy density, high working voltage, long service life, no memory effect, non-pollution and the like. With the intellectualization and the multi-functionalization of mobile devices, the power consumption increases sharply, making a higher requirement to the energy density of lithium-ion battery.

Sony has developed lithium-ion battery of graphite type since 1991, and after 20 years of development, the energy density approaches to the limit. While some key problems for the development of new chemical systems are to be resolved, such as the self-pulverization brought by the expansion after silicon-based negative active material cycling, poor high temperature cycling performance of the positive active material at high voltage, poor stability of electrolyte at high voltage, gas production by the reaction of positive active material with electrolyte and the like.

The promotion of the energy density has run into the bottleneck. To improve user experience, the development of lithium-ion battery with fast charge at high rate can make up for the disadvantages of energy density. But when lithium-ion battery is charged quickly at high rate, the electrode polarization of lithium-ion battery is serious, and the current per unit area increases, and the negative electrode quickly reaches to the potential of the lithium precipitation. Plenty of lithium ions diffusing from the positive electrode to the negative electrode can't be accepted by the negative in time. The precipitation of lithium on the negative electrode surface causes quick fade of the lithium-ion battery capacity. And the accumulation of lithium dendritic crystal on the electrode surface will impale the separator easily and pose a big threat to the safety performance of battery.

### DISCLOSURE

In view of the problems mentioned in background, the present invention aims to provide a lithium-ion battery, which can be charged quickly at high rate, with excellent safety performance and cycle performance.

In order to achieve above object, the present invention provides a lithium-ion battery, which includes:

a positive electrode including a positive current collector and a positive conductive membrane which is formed on the surface of the positive current collector by coating, drying and compacting a positive mixture slurry containing a positive active material, a positive conductive additive and a positive binder; a negative electrode including a negative current collector and a negative conductive membrane which is formed on the surface of the negative current collector by coating, drying and compacting a negative mixture slurry containing a negative active material, a negative conductive additive and a negative binder; a separator; an electrolyte; and a packaging foil. The compacted density of the positive conductive membrane is at a range from 3.9 g/cm³ to 4.4 g/cm³; the compacted density of negative conductive membrane is at a range from 1.55 g/cm³ to 1.8 g/cm³; the ratio of the capacity of the negative active material to the capacity of the positive active material CB is at a range from 1 to 1.4.

The benefits of the present invention include:

The lithium-ion battery of the present invention can be charged quickly at high rate.

The lithium-ion battery of the present invention has excellent safety performance and cycle performance.

### EXAMPLES

The lithium-ion battery of the present invention is illustrated in details, referring to Examples, Comparative Examples and Testing results.

First of all, the lithium-ion battery of the present invention includes: a positive electrode including a positive current collector and a positive conductive membrane which is formed on the surface of the positive current collector by coating, drying and compacting a positive mixture slurry containing a positive active material, a positive conductive additive and a positive binder; a negative electrode including a negative current collector and a negative conductive membrane which is formed on the surface of the negative current collector by coating, drying and compacting a negative mixture slurry containing a negative active material, a negative conductive additive and a negative binder; a separator; an electrolyte; and a packaging foil. The compacted density of the positive conductive membrane is at a range from 3.9 g/cm³ to 4.4 g/cm³; the compacted density of negative conductive membrane is at a range from 1.55 g/cm³ to 1.8 g/cm³; the ratio of the capacity of the negative active material to the capacity of the positive active material CB is at a range from 1 to 1.4.

In said lithium-ion battery of the present invention, on the one hand the lithium ion diffusion in negative electrode is accelerated by reducing the negative electrode polarization; on the other hand the diffusion velocity of lithium ion in positive electrode is slowed down by increasing the positive electrode polarization. Thus the charging process transforms quickly from charging with a constant current to charging with a constant voltage. The electrical current decreases gradually, and the amount of lithium ion diffusing from the positive electrode to the negative electrode per unit time is decreased. So the formation of lithium dendrite on the negative electrode surface can be effectively avoided, and the lithium-ion battery has excellent safety performance and cycle performance.

To reduce the negative electrode polarization, (1) at coating process, the ratio of the capacity of the negative active material to the capacity of the positive active material (CB) is adjusted as large as possible. Because at the same SOC, if the CB of the all-battery is smaller, the lithium intercalation of the negative electrode is more sufficient, and the negative electrode potential is lower. In the charging process, it is shown as that the negative electrode reaches the precipitation potential of lithium quickly, making the precipitation of lithium easier. When the CB increases, the negative electrode potential is improved, and the lithium precipitation on the negative electrode surface can be effectively avoided, and the fast charging capability of lithium-ion battery at high rate can be improved. Meanwhile a higher CB easily leads to a lower energy density of lithium-ion battery, so the CB of the present invention is at a range from 1 to 1.4; (2) at cold compacting step, the porosity of the negative conductive membrane can be increased by decreasing the compacted density of negative conductive membrane. And then the polarization on negative electrode surface is decreased, making the current distribution more uniform along the thickness direction. More negative active materials accept Li⁺ simultaneously in fast charge at high rate to avoid the lithium precipitation on the negative electrode surface. But a lower compacted density of negative conductive membrane makes the porosity of negative conductive membrane too high and the energy density of lithium-ion battery too low. So in the present invention, the compacted density of negative conductive membrane is at a range from 1.55 g/cm³ to 1.8 g/cm³.

To increase the positive electrode polarization, at cold compacting step, increase in the compacted density of positive conductive membrane and decrease in the channel for lithium ion diffusion make the charging quickly transform to a constant voltage charging and the current decrease. Thus the lithium precipitation on the negative electrode surface can be effectively avoided. But a too high compacted density of positive conductive membrane easily leads to the fracture of positive electrode, which is harmful for the safety performance and cycle performance of lithium-ion battery. So in the present invention, the compacted density of positive conductive membrane is at a range from 3.9 g/cm³ to 4.4 g/cm³.

In said lithium-ion battery of the present invention, the compacted density of said positive conductive membrane is at a range from 3.95 g/cm³ to 4.35 g/cm³.

In said lithium-ion battery of the present invention, the compacted density of said negative conductive membrane is at a range from 1.55 g/cm³ to 1.75 g/cm³.

In said lithium-ion battery of the present invention, the ratio of the capacity of the negative active material to the capacity of the positive active material (CB) is at a range from 1.03 to 1.2.

In said lithium-ion battery of the present invention, the charging rate of said lithium-ion battery is at a range from 1.3 C to 5 C.

In said lithium-ion battery of the present invention, in formation of the negative conductive membrane, the coating weight of solid components in the negative mixture slurry on the surface of the negative current collector is at a range from 120 mg/1540.25 mm² to 190 mg/1540.25 mm²; in formation of the positive conductive membrane, the coating weight of solid components in the positive mixture slurry on the surface of the positive current collector is at a range from 230 mg/1540.25 mm² to 380 mg/1540.25 mm². The coating weight of solid components in conductive membrane can be reduced in the design of lithium-ion battery, because when the coating weight of solid components in conductive membrane is reduced, the current per unit area is decreased, and the concentration polarization along the thickness direction of electrode is alleviated. Thus the precipitation of lithium on the negative electrode surface in fast charging can be effectively avoided.

In said lithium-ion battery of the present invention, said positive active material is at least one selected from cobalt acid lithium (LiCoO₂), manganic acid lithium (LiMn₂O₄), lithium iron phosphate (LiFePO₄) or ternary compound (NCM). Wherein, the ternary compound is at least one selected from the lithium nickel manganese cobalt oxides.

In said lithium-ion battery of the present invention, said negative active material is carbon material which is at least one selected from soft carbon, hard carbon, artificial graphite, natural graphite or mesocarbon microbead.

In said lithium-ion battery of the present invention, said separator is at least one selected from polyethylene (PE) membrane or polypropylene (PP) membrane. The thickness of said separator is from 5 μm to 30 μm.

In said lithium-ion battery of the present invention, said electrolyte is a non-water electrolyte containing a non-water organic solvent and a lithium salt.

In said lithium-ion battery of the present invention, said non-water organic solvent is a mixture of chain ester and cyclic ester; said chain ester is at least one selected from dimethyl carbonate DMC, diethyl carbonate DEC, ethyl methyl carbonate EMC, methyl propyl carbonate MPC, dipropyl carbonate DPC, fluorine-containing chain ester, sulphur-containing chain ester or unsaturated carbon-carbon bond-containing chain ester; said cyclic ester is at least one selected from ethylene carbonate EC, propylene carbonate PC, vinylene carbonate VC, γ-butyrolactone γ-BL, trimethylene sulfite, fluorine-containing cyclic ester, other sulphur-containing cyclic ester or other unsaturated carbon-carbon bond-containing cyclic ester.

In said lithium-ion battery of the present invention, said lithium salt is at least one selected from LiPF₆, LiBF₄, LiClO₄, LiCF₃SO₃, LiN(SO₂CF₃)₂ or LiN(SO₂C₂F₅)₂. Preferably, the lithium salt is LiPF₆.

The Examples using the lithium-ion battery and the electrolyte of the present invention are shown below.

### Example 1

### (1) Preparation of Positive Electrode

N-methyl pyrrolidone (NMP) was used as a solvent to dissolve the positive binder polyvinylidene fluoride (PVDF). And a binder solution with mass fraction of 8% was obtained. Then LiCoO₂ (capacity per gram was 160 mAh/g) used as a positive active material and carbon black used as positive conductive additive were added into the binder solution under stirring. The homogeneous positive mixture slurry was obtained by further stiffing. In the positive mixture slurry, the weight ratio of LiCoO₂, PVDF and carbon black was 97:1.5:1.5. Then the positive mixture slurry was coated evenly on the aluminum foil used as the positive current collector and the coating weight was 334 mg/1540.25 mm². After drying at 120° C., the positive conductive membrane was obtained. The positive conductive membrane was cold compacted and adjusted the thickness, making its compacted density become 3.95 g/cm³. After being cut, the positive electrode of 72 mm×1024 mm was obtained.

### (2) Preparation of the Negative Electrode

Artificial graphite (capacity per gram was 360 mAh/g) used as negative active materials, sodium carboxymethyl cellulose (CMC) used as thickener, styrene butadiene rubber (SBR) used as positive binder and carbon black used as positive conductive additive were mixed with the solvent deionized water according to the weight ratio of 96:1.5:1.5:1, and then the homogeneous negative mixture slurry was obtained by stiffing. Then the negative mixture slurry was coated evenly on the copper foil used as the negative current collector and the coating weight was 155 mg/1540.25 mm². After drying at 90° C., the negative conductive membrane was obtained. Then the negative conductive membrane was cold compacted and adjusted the thickness, making its compacted density become 1.75 g/cm³. After being cut, the negative electrode of 73.5 mm×1036 mm was obtained.

### (3) Preparation of the Electrolyte

In electrolyte, LiPF₆ was used as lithium salt with the concentration of 1 mol/L. A mixture of ethylene carbonate (EC) and dimethyl carbonate (DMC) (the mass ratio was 1:1) was used as an non-water organic solvent.

### (4) Preparation of the Lithium-Ion Battery

The positive electrode, the negative electrode and PE separator with 16 μm thickness were coiled to form a square naked-cell. Then the naked-cell was put into aluminum-plastic outer packing film. After being filled with electrolyte, being sealed and formation, the lithium-ion battery with CB of 1.03 was obtained.

### Wherein:

CB=the capacity of negative active material/the capacity of positive active material=(negative coating weight per unit area×the weight ratio of negative active materials×the capacity per gram of negative active material)/(positive coating weight per unit area×the weight ratio of positive active materials×the capacity per gram of positive active material).

### Example 2

The lithium-ion battery was prepared using the method same as Example 1, except the differences as follows:

(1) In formation of the positive conductive membrane, the coating weight of solid components in the positive mixture slurry on the surface of the positive current collector was 314 mg/1540.25 mm²;

(4) The CB was 1.1.

### Example 3

The lithium-ion battery was prepared using the method same as Example 1, except the differences as follows:

(1) In formation of the positive conductive membrane, the coating weight of solid components in the positive mixture slurry on the surface of the positive current collector was 288 mg/1540.25 mm²;

(4) The CB was 1.2.

### Example 4

The lithium-ion battery was prepared using the method same as Example 1, except the differences as follows:

(1) In formation of the positive conductive membrane, the coating weight of solid components in the positive mixture slurry on the surface of the positive current collector was 265 mg/1540.25 mm²;

(4) The CB was 1.3.

### Example 5

The lithium-ion battery was prepared using the method same as Example 1, except the differences as follows:

(1) In formation of the positive conductive membrane, the coating weight of solid components in the positive mixture slurry on the surface of the positive current collector was 325 mg/1540.25 mm²; the compacted density of positive conductive membrane was 4 g/cm³;

(4) The CB was 1.06.

### Example 6

The lithium-ion battery was prepared using the method same as Example 5, except the difference as follows:

(2) The compacted density of negative conductive membrane was 1.65 g/cm³.

### Example 7

The lithium-ion battery was prepared using the method same as Example 5, except the difference as follows:

(2) The compacted density of negative conductive membrane was 1.55 g/cm³.

### Example 8

The lithium-ion battery was prepared using the method same as Example 1, except the differences as follows:

(1) In formation of the positive conductive membrane, the coating weight of solid components in the positive mixture slurry on the surface of the positive current collector was 300 mg/1540.25 mm²; the compacted density of positive conductive membrane was 3.95 g/cm³;

(2) The compacted density of negative conductive membrane was 1.6 g/cm³;

(4) The CB was 1.15.

### Example 9

The lithium-ion battery was prepared using the method same as Example 8, except the difference as follows:

(1) The compacted density of positive conductive membrane was 4.1 g/cm³.

### Example 10

The lithium-ion battery was prepared using the method same as Example 8, except the difference as follows:

(1) The compacted density of positive conductive membrane was 4.25 g/cm³.

### Example 11

The lithium-ion battery was prepared using the method same as Example 8, except the difference as follows:

(1) The compacted density of positive conductive membrane was 4.35 g/cm³.

### Example 12

The lithium-ion battery was prepared using the method same as Example 1, except the differences as follows:

(1) In formation of the positive conductive membrane, the coating weight of solid components in the positive mixture slurry on the surface of the positive current collector was 380 mg/1540.25 mm²; the compacted density of positive conductive membrane was 4.1 g/cm³;

(2) In formation of the negative conductive membrane, the coating weight of solid components in negative mixture slurry on the surface of the negative current collector was 185 mg/1540.25 mm², the compacted density of negative conductive membrane was 1.65 g/cm³;

(4) The CB was 1.08.

### Example 13

The lithium-ion battery was prepared using the method same as Example 12, except the differences as follows:

(1) In formation of the positive conductive membrane, the coating weight of solid components in the positive mixture slurry on the surface of the positive current collector was 340 mg/1540.25 mm²;

(2) In formation of the negative conductive membrane, the coating weight of solid components in negative mixture slurry on the surface of the negative current collector was 165 mg/1540.25 mm².

### Example 14

The lithium-ion battery was prepared using the method same as Example 12, except the differences as follows:

(1) In formation of the positive conductive membrane, the coating weight of solid components in the positive mixture slurry on the surface of the positive current collector was 290 mg/1540.25 mm²;

(2) In formation of the negative conductive membrane, the coating weight of solid components in negative mixture slurry on the surface of the negative current collector was 141 mg/1540.25 mm².

### Example 15

The lithium-ion battery was prepared using the method same as Example 12, except the differences as follows:

(1) In formation of the positive conductive membrane, the coating weight of solid components in the positive mixture slurry on the surface of the positive current collector was 250 mg/1540.25 mm²;

(2) In formation of the negative conductive membrane, the coating weight of solid components in negative mixture slurry on the surface of the negative current collector was 121 mg/1540.25 mm².

The testing method and testing results of the lithium-ion batteries provided in the present invention are shown below.

(1) Cycle performance test of the lithium-ion battery

At 25° C., the battery was charged with constant current of 2.5 C until the voltage reached 4.35V, and then the battery was charged with constant voltage of 4.35V until the current reached the cut-off current of 0.05 C, and then the battery was discharged with constant current of 1 C until the voltage reached the cut-off voltage of 3V, which was a charge/discharge cycle. The charge/discharge cycle was repeated 350 times.

The capacity retention after 350 cycles (%)=the discharge capacity of the 350th cycle/the discharge capacity of initial cycle×100%.

### (2) Test for Lithium Precipitation of Negative Electrode

At 25° C., the battery was charged with constant current of 2.5 C until the voltage reached 4.35V, and then the battery was charged with constant voltage of 4.35V until the current reached the cut-off current of 0.05 C, and then the battery was discharged with constant current of 1 C until the voltage reached the cut-off voltage of 3V, which was a charge/discharge cycle. The charge/discharge cycle was repeated 10 times. After cycles, the lithium-ion battery was full charged and took apart, and lithium precipitation on the surface of negative electrode was observed. Therein, the degree of lithium precipitation was graded into no lithium precipitation, slight lithium precipitation, medium lithium precipitation and serious lithium precipitation. No lithium precipitation meant that the area ratio of lithium precipitation region on the surface of negative electrode was 0%. Slight lithium precipitation meant that the area ratio of lithium precipitation region on the surface of negative electrode was less than 20%. Medium lithium precipitation meant that the area ratio of lithium precipitation region on the surface of negative electrode was at a range from 20% to 70%. Serious lithium precipitation meant that the area ratio of lithium precipitation region on the surface of negative electrode was more than 70%.

Table 1 showed the parameters and results of performance test from Example 1 to Example 15.

TABLE 1
The parameters and results of performance from Example 1 to Example 15

| | | Positive electrode | | Negative electrode | | Lithium | Capacity |
|---|---|---|---|---|---|---|---|
| | | Compacted | Coating | Compacted | Coating | precipitation | retention |
| | | density | weight mg/ | density | weight mg/ | of negative | after 350 |
| | CB | g/cm³ | 1540.25 mm² | g/cm³ | 1540.25 mm² | electrode | cycles |
| Example | 1.03 | 3.95 | 334 | 1.75 | 155 | serious | 50% |
| 1 | | | | | | lithium | |
| | | | | | | precipitation | |
| Example | 1.1 | 3.95 | 314 | 1.75 | 155 | medium | 70% |
| 2 | | | | | | lithium | |
| | | | | | | precipitation | |
| Example | 1.2 | 3.95 | 288 | 1.75 | 155 | slight | 82% |
| 3 | | | | | | lithium | |
| | | | | | | precipitation | |
| Example | 1.3 | 3.95 | 265 | 1.75 | 155 | no lithium | 93% |
| 4 | | | | | | precipitation | |
| Example | 1.06 | 4 | 325 | 1.75 | 155 | serious | 56% |
| 5 | | | | | | lithium | |
| | | | | | | precipitation | |
| Example | 1.06 | 4 | 325 | 1.65 | 155 | medium | 72% |
| 6 | | | | | | lithium | |
| | | | | | | precipitation | |
| Example | 1.06 | 4 | 325 | 1.55 | 155 | slight | 83% |
| 7 | | | | | | lithium | |
| | | | | | | precipitation | |
| Example | 1.15 | 3.95 | 300 | 1.6 | 155 | medium | 73% |
| 8 | | | | | | lithium | |
| | | | | | | precipitation | |
| Example | 1.15 | 4.1 | 300 | 1.6 | 155 | slight | 84% |
| 9 | | | | | | lithium | |
| | | | | | | precipitation | |
| Example | 1.15 | 4.25 | 300 | 1.6 | 155 | no lithium | 93% |
| 10 | | | | | | precipitation | |
| Example | 1.15 | 4.35 | 300 | 1.6 | 155 | no lithium | 96% |
| 11 | | | | | | precipitation | |
| Example | 1.08 | 4.1 | 380 | 1.65 | 185 | serious | 55% |
| 12 | | | | | | lithium | |
| | | | | | | precipitation | |
| Example | 1.08 | 4.1 | 340 | 1.65 | 165 | medium | 71% |
| 13 | | | | | | lithium | |
| | | | | | | precipitation | |
| Example | 1.08 | 4.1 | 290 | 1.65 | 141 | slight | 84% |
| 14 | | | | | | lithium | |
| | | | | | | precipitation | |
| Example | 1.08 | 4.1 | 250 | 1.65 | 121 | no lithium | 95% |
| 15 | | | | | | precipitation | |

By the contrast from Example 1 to Example 4, it was observed that the lithium precipitation on the surface of negative electrode was improved significantly and the capacity retention of the lithium-ion battery increased after 350 cycles, with the decrease of the coating weight of solid components in the positive conductive membrane and the increase of the CB. When the CB was too small, the capacity retention after 350 cycles was low.

By the contrast from Example 5 to Example 7, it was observed that the lithium precipitation on the surface of negative electrode was improved significantly and the capacity retention of the lithium-ion battery increased after 350 cycles, with the decrease of the compacted density of negative conductive membrane. When the compacted density of negative conductive membrane was too high, the capacity retention after 350 cycles was low.

By the contrast from example 8 to example 11, it was observed that the lithium precipitation on the surface of negative electrode was improved significantly and the capacity retention of the lithium-ion battery increased after 350 cycles, with the increase of the compacted density of positive conductive membrane. When the compacted density of positive conductive membrane was too small, the capacity retention after 350 cycles was low.

By the contrast from example 12 to example 15, it was observed that the lithium precipitation on the surface of negative electrode was improved significantly and the capacity retention of the lithium-ion battery increased after 350 cycles, with the simultaneous decrease of the coating weights of solid components in the positive conductive membrane and in the negative conductive membrane. When the coating weights of solid components in the positive conductive membrane and in the negative conductive membrane were too high, the capacity retention after 350 cycles was low.

1. A lithium-ion battery includes:
a positive electrode including a positive current collector and a positive conductive membrane which is formed on the surface of the positive current collector by coating, drying and compacting a positive mixture slurry containing a positive active material, a positive conductive additive and a positive binder;
a negative electrode including a negative current collector and a negative conductive membrane which is formed on the surface of the negative current collector by coating, drying and compacting a negative mixture slurry containing a negative active material, a negative conductive additive and a negative binder;
a separator;
an electrolyte; and
a packaging foil;
wherein,
the compacted density of the positive conductive membrane is at a range from 3.9 g/cm³ to 4.4 g/cm³;
the compacted density of the negative conductive membrane is at a range from 1.55 g/cm³ to 1.8 g/cm³;
the ratio of the capacity of the negative active material to the capacity of the positive active material CB is at a range from 1 to 1.4.

2. A lithium-ion battery according to claim 1, wherein, the compacted density of said positive conductive membrane is at a range from 3.95 g/cm³ to 4.35 g/cm³.

3. A lithium-ion battery according to claim 1, wherein, the compacted density of said negative conductive membrane is at a range from 1.55 g/cm³ to 1.75 g/cm³.

4. A lithium-ion battery according to claim 1, wherein, the ratio of the capacity of the negative active material to the capacity of the positive active material CB is at a range from 1.03 to 1.2.

5. A lithium-ion battery according to claim 1, wherein, the charging rate of said lithium-ion battery is at a range from 1.3 C to 5 C.

6. A lithium-ion battery according to claim 1, wherein,
in formation of the negative conductive membrane, the coating weight of solid components in the negative mixture slurry on the surface of the negative current collector is at a range from 120 mg/1540.25 mm² to 190 mg/1540.25 mm²;
in formation of the positive conductive membrane, the coating weight of solid components in the positive mixture slurry on the surface of the positive current collector is at a range from 230 mg/1540.25 mm² to 380 mg/1540.25 mm².

7. A lithium-ion battery according to claim 1, wherein, said positive active material is at least one selected from lithium cobaltate LiCoO₂, lithium manganate LiMn₂O₄, lithium iron phosphate LiFePO₄ or ternary material NCM.

8. A lithium-ion battery according to claim 1, wherein, said negative active material is carbon material which is at least one selected from soft carbon, hard carbon, artificial graphite, natural graphite or mesocarbon microbead.

9. A lithium-ion battery according to claim 1, wherein, said electrolyte is a non-water electrolyte containing a non-water organic solvent and a lithium salt.

10. A lithium-ion battery according to claim 9, wherein,
said non-water organic solvent is a mixture of chain ester and cyclic ester;
said chain ester is at least one selected from dimethyl carbonate DMC, diethyl carbonate DEC, ethyl methyl carbonate EMC, methyl propyl carbonate MPC, dipropyl carbonate DPC, fluorine-containing chain ester, sulphur-containing chain ester or unsaturated carbon-carbon bond-containing chain ester;
said cyclic ester is at least one selected from ethylene carbonate EC, propylene carbonate PC, vinylene carbonate VC, γ-butyrolactone γ-BL, trimethylene sulfite, fluorine-containing cyclic ester, other sulphur-containing cyclic ester or other unsaturated carbon-carbon bond-containing cyclic ester;
said lithium salt is at least one selected from LiPF₆, LiBF₄, LiClO₄, LiCF₃SO₃, LiN(SO₂CF₃)₂ or LiN(SO₂C₂F₅)₂.
